(19) United States
(12) Patent Application Publication
(10) Pub. No.: US 2025/0088919 A1
(43) Pub. Date: Mar. 13, 2025

(54) DISPLAY COMMUNICATION PROCESSING APPARATUS, CONTROL METHOD FOR DISPLAY COMMUNICATION PROCESSING APPARATUS, TERMINAL APPARATUS AND PROGRAM THEREOF

(71) Applicant: NEC Corporation, Tokyo (JP)

(72) Inventors: Masakazu ONO, Tokyo (JP); Shingo WATANABE, Tokyo (JP); Kohei YOSHIDA, Tokyo (JP); Kenji WAKAFUJI, Tokyo (JP)

(73) Assignee: NEC Corporation, Tokyo (JP)

(21) Appl. No.: 18/817,463

(22) Filed: Aug. 28, 2024

(30) Foreign Application Priority Data
Sep. 7, 2023 (JP) 2023-145442

(51) Int. Cl. H04W 36/00; G09G 5/00

(52) U.S. Cl. CPC H04W 36/0064; G09G 5/003; G09G 2370/16

(57) ABSTRACT

A display communication processing apparatus including a plurality of antennas, a link controller, a communication controller and a display, wherein the plurality of antennas are provided on a display screen of the display, a with link a n adjacent display communication processing apparatus via a first antenna of the plurality of antennas is established by the link controller, a network is connected via the first antenna by the communication controller, a predetermined communication setting for a third antenna of the plurality of antennas is set by the communication controller, when a connection request is received from a terminal apparatus via a second antenna of the plurality of antennas, and a service from the network to the terminal apparatus via the third antenna is provided by the communication controller.

### CROSS REFERENCE TO RELATED APPLICATION

The present invention is based on the priority claim of Japanese Patent Application No. 2023-145442 (filed on Sep. 7, 2023), the entire contents of which are incorporated herein by reference.

### FIELD

The present invention relates to a display communication processing apparatus, a control method for a display processing apparatus, a terminal 15 communication apparatus and a program.

### BACKGROUND

There is a following document regarding a digital signage (hereinafter also referred to as a display communication processing apparatus) that provides information to a terminal apparatus.

Patent Literature (PTL) 1 relates to a signage apparatus in which a digital signage apparatus is provided with a plurality of wireless access points and provides image information to a mobile terminal connected to each of the wireless access points.

[PTL 1] JP Patent Kokai Publication No. 2013-080123 A

### SUMMARY

The following analysis is given by the inventors.

Conventionally, in digital signage technology, power sources and wired communication cables have been layed over long distances to fixedly installed. In this case, variety of incidental works are required to protect not only the signage itself but also the cables from the perspective of earthquake resistance, resulting in issues such as flexibility and a delay of timing for installing the signage.

In current digital signage technology, cable length design, cable installation cost calculations and repair calculations are required, and also it cannot be used easily and timely since pre-installation work is required because of long and heavy cabling. That is, there is a problem that installation design and construction take a lot of time.

It is an object of the present invention to provide a display communication processing apparatus, a control method for a display communication processing apparatus, a terminal apparatus and a program that contribute to reducing the time required for the installation design and construction of a display communication processing apparatus.

According to a first aspect of the present invention, there can be provided display communication processing apparatus including a plurality of antennas, a link controller, a communication controller and a display, wherein
the plurality of antennas are provided on a display screen of the display,
a link with an adjacent display communication processing apparatus via a first antenna of the plurality of antennas is established by the link controller, a network is connected via the first antenna by the communication controller,
a predetermined communication setting for a third antenna of the plurality of antennas is set by the communication controller, when a connection request is received from a terminal apparatus via a second antenna of the plurality of antennas, and
a service from the network to the terminal apparatus via the third antenna is provided by the communication controller.

According to a second aspect of the present invention, there can be provided a terminal apparatus that transmits a request for a location information service to which identification information of a terminal apparatus provided by a display communication processing apparatus is added to the display communication processing apparatus.

According to a third aspect of the present invention, there can be provided a control method for a display communication processing apparatus performed by a computer included in the display communication processing apparatus including a plurality of antennas and a display, the plurality of antennas are provided on a display screen of the display, the method comprising:
establishing a link with an adjacent display communication processing apparatus via a first antenna of the plurality of antennas;
connecting to a network via the first antenna;
performing a predetermined communication setting for a third antenna of the plurality of antennas, when a connection request is received from a terminal apparatus via a second antenna of the plurality of antennas; and
providing a service from the network to the terminal apparatus via the third antenna.

According to a fourth aspect of the present invention, there can be provided a program that causes a computer of a display communication processing apparatus including a plurality of antennas and a display, the plurality of antennas being provided on a display screen of the display to perform:
a process for establishing a link with an adjacent display communication processing apparatus via a first antenna of the plurality of antennas;
a process for connecting to a network via the first antenna;
a process for performing a predetermined communication setting for a third antenna of the plurality of antennas, when a connection request is received from a terminal apparatus via a second antenna of the plurality of antennas; and
a process for providing a service from the network to the terminal apparatus via the third antenna.

Note that, these programs can be stored on a computer readable storage medium. The storage medium can be a non-transitory medium such as a semiconductor memory, a hard disk, a magnetic recording medium, an optical recording medium, etc. The present invention can also be embodied as a computer program product.

According to the present invention, a display communication processing apparatus, a control method for a display communication processing apparatus, a terminal apparatus and a program that contribute to reducing the time required for the installation design and construction of a display communication processing apparatus are provided.

### BRIEF DESCRIPTION OF DRAWINGS

FIG. 1 is a block diagram showing an example of a configuration of a first display communication processing apparatus.

FIG. 2 is a block diagram showing an example of a configuration of a display communication processing system.

FIG. 3 is a block diagram showing an example of the configuration of a second display communication processing apparatus.

FIG. 4 is a sequence diagram showing an example of a communication control operation of a priority 1 of the second display communication processing apparatus.

FIG. 5 is a flowchart showing an example of a communication control operation of a priority 2 of the second display communication processing apparatus.

FIG. 6 is a sequence diagram showing an example of the communication control operation of a priority 2 of the second display communication processing apparatus.

FIG. 7 is a flowchart showing an example of a communication control operation of a priority 3 of the second display communication processing apparatus.

FIG. 8 is a flowchart showing an example of the communication control operation of a priority 3 of the second display communication processing apparatus.

FIG. 9 is a flowchart showing an example of the communication control operation of a priority 3 of the second display communication processing apparatus.

FIG. 10 is a flowchart showing an example of a handover operation of the second display communication processing apparatus.

FIG. 11 is a flowchart showing a server environment preparation operation of a service providing server for a service utilizing a location information.

FIG. 12 is a flowchart showing a preparation operation of the second display communication processing apparatus for the terminal apparatus at the time of the service utilizing location information.

FIG. 13 is a flowchart showing a processing operation of the terminal apparatus at the time of connection at the time of the service utilizing the location information.

FIG. 14 is a flowchart showing a processing operation performed by the second display communication processing apparatus at the time of connection of the terminal apparatus at the time of the service utilizing the location information.

FIG. 15 is a flowchart showing a location information processing operation of the second display communication processing apparatus at the time of connection of the terminal apparatus at the time of the service utilizing the location information.

FIG. 16 is a flowchart showing a processing operation of a service providing server at the time of the service utilizing the location information.

FIG. 17 is a flowchart showing a processing operation of the communication control server at the time of the service utilizing the location information.

FIG. 18 is a flowchart showing a service information providing operation by the second display communication processing apparatus at the time of the service utilizing the location information.

FIG. 19 is a flowchart showing a service information providing operation by the second display communication processing apparatus at the time of the service utilizing the location information.

FIG. 20 is a diagram illustrating a configuration of a computer that makes up the display communication processing apparatus.

### DETAILED DESCRIPTIONS

Each embodiment described below can be appropriately combined with another embodiment, and the present invention is not limited to each embodiment.

First, an overview of an example embodiment will be described with reference to the drawings. Note, in the following outline, the reference signs of the drawings are denoted to each element as an example for the sake of convenience as an example to facilitate understanding, and are not intended to limit the present invention to the illustrated modes. In addition, connection lines between blocks in the drawings and the like referred to in the following description include both one-way and two-way directions. A one-way arrow schematically illustrates a principal signal (data) flow and does not exclude bidirectionality.

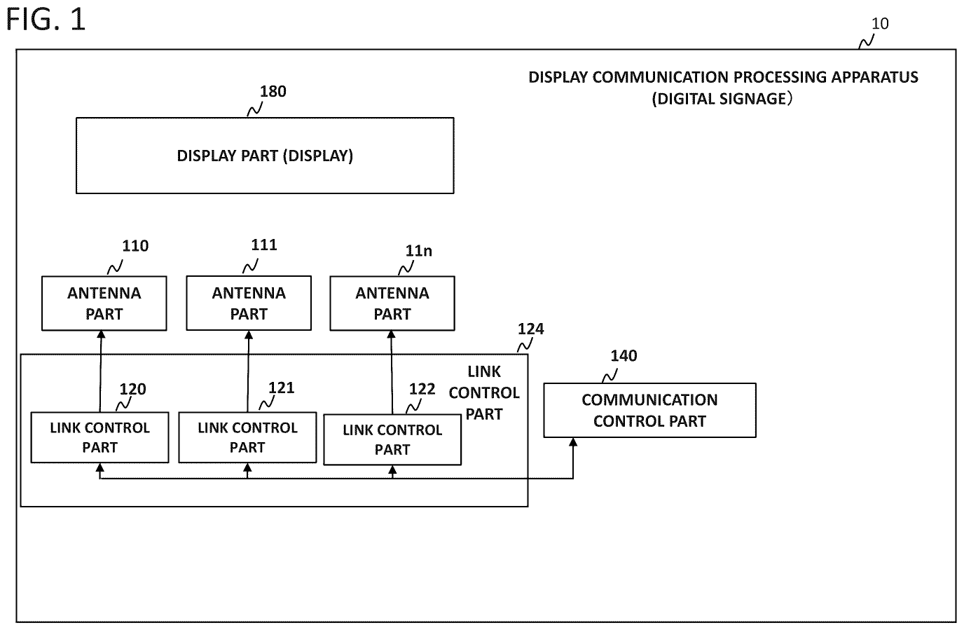

FIG. 1 is a diagram illustrating an example of a configuration of first display communication a processing apparatus. An overview of an example embodiment will be described with reference to FIG. 1 Referring to FIG. 1, the first display communication processing apparatus (also referred to as digital signage) 10 includes, as an example, a plurality of antenna parts (antennas) 110 to 11n, a link control part (link controller) 124, a communication control part (communication controller) 140 and a display part (display) 180. Note that, one link control part 124 may control the plurality of the antenna parts 110 to 11n. Also, the link control part 124 may have a plurality of link control parts 120 to 122 that control the respective antenna parts 110 to 11n.

The plurality of antenna parts antenna parts 110 to 11n are provided on the display screen of the display part 180, and the plurality of antenna parts 110 to 11n include a control channel antenna part (also referred to as a first antenna part (first antenna)) 110, a scanning antenna part (also referred to as a second antenna part (second antenna)) 111 and a service antenna part (also referred to as a third antenna part (third antenna)) 11n. Note that, the antenna part provided on the display screen of the display part 180 of the display communication processing apparatus 10 may be configured as a massive-element display antennas.

The link is established with an adjacent display communication processing apparatus by the link control part 120 via the control channel antenna part 110.

A connection to the network is established via the control channel antenna part 110 by the communication control part 140.

When the connection request is received from a terminal apparatus via the scan antenna part 111, a predetermined communication setting for the service antenna part 11n is performed by the communication control part 140.

A service is provided from the network to the terminal apparatus by the communication control part 140 via the service antenna part 11n.

As described above, according to the example embodiment, by establishing a link with an adjacent display communication processing apparatus via the control channel antenna part 110 by the link control part 120, the cable length design with the adjacent display communication processing apparatus, cost calculation associated with laying the cable and modification calculations etc. become unnecessary, and since there is no cable wiring, no prior construction work is required, and the display communication processing apparatus can be used easily and timely.

As described above, according to the example embodiment, it is possible to provide a display communication processing apparatus, a control method for a display communication processing apparatus, a terminal apparatus and a program thereof that contribute to reducing the time required for installation design and construction of the display communication processing apparatus.

### First Example Embodiment

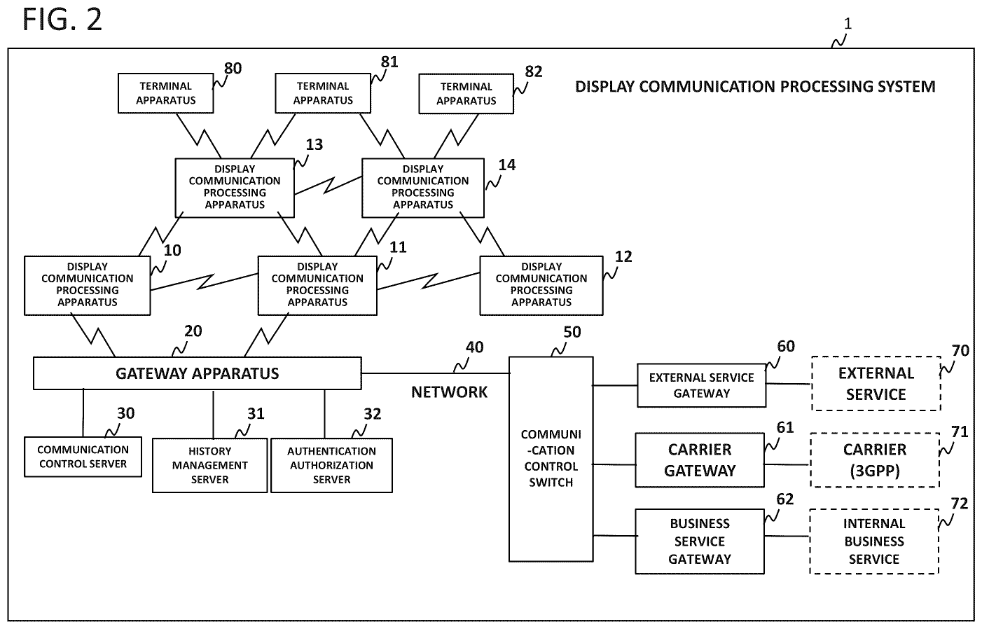

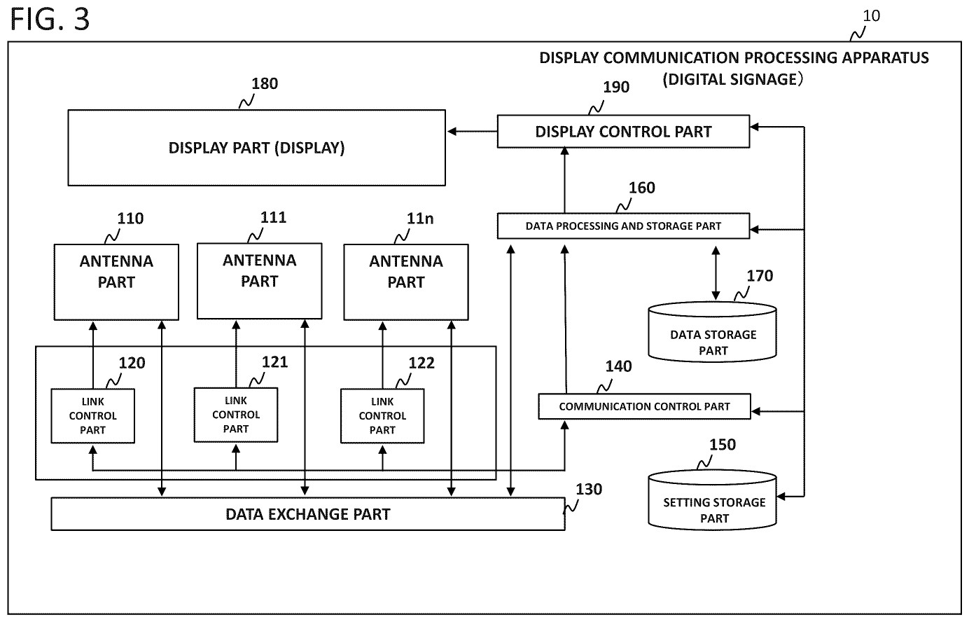

Next, a first example embodiment will be described in detail with reference to the drawings. FIG. 2 is a block diagram showing an example of the configuration of a display communication processing system 1. Further, FIG. 3 is a block diagram showing an example of the configuration of a second display communication processing apparatus. Note that, in FIGS. 2 and 3, components denoted by the same reference signs as those in FIG. 1 indicate the same components. Referring to FIG. 2, the display communication processing system 1 includes, as an example, display communication processing apparatus (also referred to as digital signage) 10 to 14, a gateway apparatus 20, a communication control server 30, a history management server 31, an authentication authorization server 32, a network 40, a communication control switch 50, an external service gateway 60 providing external services 70, a carrier gateway 61 providing connection to a carrier 71 and a business service gateway 62 providing internal business services 72.

Referring to FIG. 3, the second display communication processing apparatus 10 includes, as an example, the plurality of antenna parts 110 to 11n, the link control parts 120 to 122, a data exchange part 130, the communication control part 140, a setting storage part 150, a data processing and storage part 160, a data storage part 170 (data storage) and the display part 180. Note that, with regard to link control parts 120 to 122, although one link control part may control the plurality of antenna parts 110 to 11n, in this first example embodiment, the description will be made assuming that the link control parts 120 to 122 control each of the antenna parts 110 to 11n. Note that, the description below will be made assuming that each of the display communication processing apparatus 10 to 14 shown in FIG. 2 are also configured similarly to the second communication processing apparatus 10 shown in FIG. 3.

Next, a detailed description will be made regarding an operation of the display communication processing system 1 and an operation of the second display communication processing apparatus 10 with reference to the drawings.

Next, a detailed description will be made regarding an example of a communication control operation of the second display communication processing apparatus 10 with reference to the drawing. In one example of the communication control operation of the second display communication processing apparatus 10, a communication control operation is executed to perform connection setting for each of priorities 1 to 3. After completion of the communication control operation for the connection setting of a priority 1, a communication control operation for the connection setting of a priority 2 is carried out, and then a communication control operation for the connection setting of a priority 3 is executed.

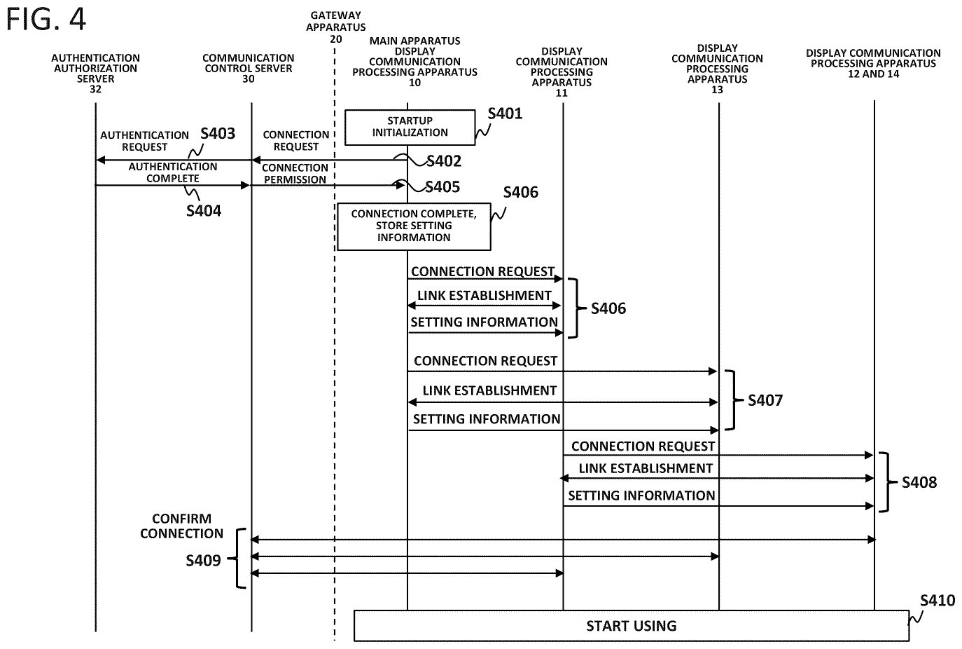

First, a description will be made regarding setting of a priority 1. FIG. 4 is a sequence diagram showing an example of a communication control operation of a priority 1 of the second display communication processing apparatus. The setting of the priority 1 is an example of an operation for establishing a control channel, when a connection/communication request for maintaining the system arrives at a specific frequency (group) f0. Note that, it is assumed that some values are set as initial values in each of the parts. Several types of initial values may be prepared, and sequential scanning may be performed until the connection is established. It is assumed that each of the apparatus is set so that it can receive a communication request at all times. For example, it is assumed that the antenna part 110 is dedicated to control.

In step S401 in FIG. 4, startup initialization is performed. In FIG. 2, among the display communication processing apparatus 10 to 14, for example, it is assumed that the display communication processing apparatus 10 is the master apparatus, and the display communication processing apparatus 11 to 14 are the slave apparatus. In the following description, the communication processing apparatus 10 is also referred to as the master apparatus display communication processing apparatus 10. The display communication processing apparatus 11 to 14 are also referred to as the slave apparatus communication processing apparatus or slave apparatus. In step S402 in FIG. 4, the master apparatus display communication processing apparatus 10 autonomously transmits the connection request from its communication control part 140 to the communication control server 30 via the gateway apparatus 20 by the antenna part 110.

In steps from S403 to S405 in FIG. 4, the connection request is made to the communication control server 30 via the gateway apparatus 20, and the communication control server 30 transmits a connection permission to the master apparatus display communication processing apparatus 10 after authentication by the authentication authorization server 32. Thereby, in step S406, the connection between the master apparatus display communication processing apparatus 10 and the communication control server 30 is completed, and a setting information is stored in the setting storage part 150 of the master apparatus display communication processing apparatus 10. In addition, the slave apparatus (display communication processing apparatus 11 to 14) startup in a standby/wait state for the connection request.

Next, in step S406, a connection is established between the master apparatus display communication processing apparatus 10 and the slave apparatus display communication processing apparatus 11. Concretely, the connection request is sent from the master apparatus display communication processing apparatus 10 to the slave apparatus display communication processing apparatus 11. When the slave apparatus display communication processing apparatus 11 receives the connection request at its antenna part 110, the link control part 120 of the slave apparatus display communication processing apparatus 11 detects it and notifies its communication control part 140 of the arrival of the connection request. The communication control part 140 processes the connection request, and in a case where it is the new connection request, performs to establish the link as follows

In link establishment, as an example, the following processes are executed:
(1) The antenna part 110 and the link control part 120 perform processing to make a transition from non-directional communication to directional communication utilizing beamforming (BF) to realize communication for preventing interference;
(2) As an example, a general apparatus authentication is performed. The authentication can be performed in cooperation with the authentication authorization server 32, or it can be also performed by utilizing the authentication information (e.g., ID (Identification)/PW (Pass Word), digital certificate, etc.) stored in the setting storage part 150;
(3) Bandwidth information required for system maintenance is exchanged between the master apparatus communication processing apparatus 10 and the slave apparatus communication processing apparatus 11 to store it in each of the setting storage part 150. (Traffic for exchanging control messages for system maintenance and the display communication processing apparatus is constructed.); and
(4) When communication is established, in order to share the setting information from the master apparatus communication processing apparatus 10 already connected to the communication control server, the setting information of the master apparatus communication processing apparatus 10 is stored in the setting storage part 150 of the slave apparatus communication processing apparatus 11. (As an example, a list of settings, an information list for access control, a list of services provided by the slave apparatus communication processing apparatus 11, etc. are also stored.)

Next, in step S407, processing similar to that in step S406 is executed between the master apparatus communication processing apparatus 10 and the slave apparatus communication processing apparatus 13, and in step S408, processing similar to that in step S406 is executed between the slave apparatus communication processing apparatus 11 and the slave apparatus communication processing apparatus 12 and 14.

Next, in step S409, a connection confirmation is performed between the communication control server 30 and each of the slave apparatus display communication processing apparatus 11 to 14, and after the confirmation, in step S410, it is started to use the master apparatus display communication processing apparatus 10 and the slave apparatus display communication processing apparatus 11 to 14.

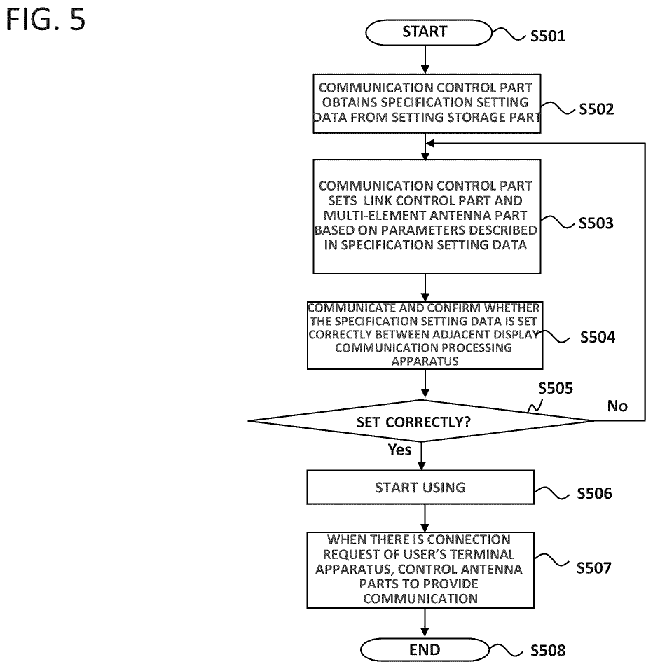

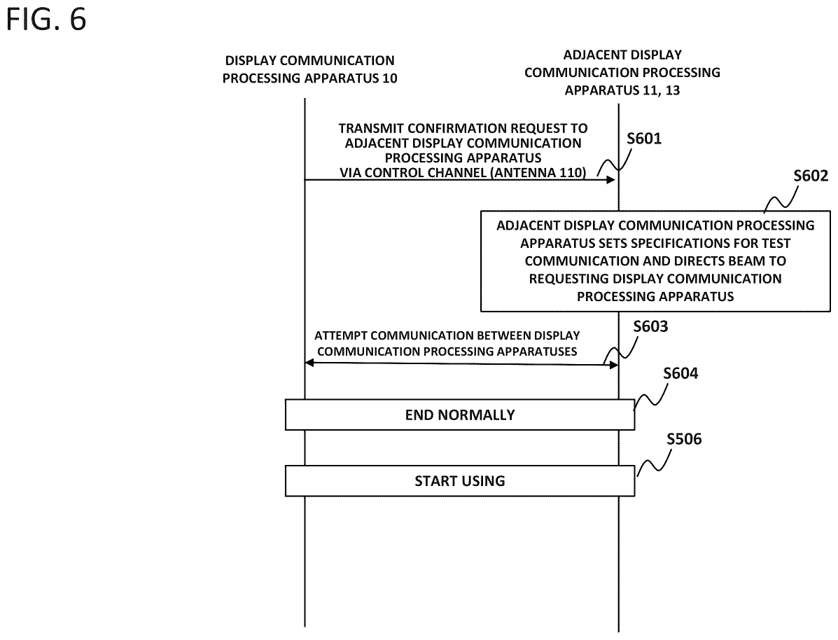

Next, a description will be made regarding the setting of a priority 2. FIG. 5 and FIG. 6 are a flowchart and a sequence diagram showing an example of the communication control operation in the priority 2 of the second display communication processing apparatus. Note that the setting of the priority 2 is referred to as a fixed setting communication setting.

Note that, in the setting of the priority 2, it is assumed that the specification setting data for the fixed setting has been stored in the setting storage part 150 of each of the display communication processing apparatus 10 to 14 by previous input or by communication of the priority 1.

One example of a communication control operation of the priority 2 executed by each of the second display communication processing apparatus 10 to 14 will be described with reference to FIG. 5.

The process starts at step S501. Next, at step S502, the communication control part 140 obtains specification setting data from the setting storage part 150.

Next, in step S503, the communication control part 140 sets the link control part 120 and the multi-element antenna part 110 based on the parameters described in the specification setting data.

Next, in step S504, since the existence of the adjacent display communication processing apparatus is clear by the setting of the priority 1, it is confirmed whether the specification setting data has been set correctly by carrying out communication between the display communication processing apparatus.

Next, in step S505, when it is confirmed that the specification setting data has been set correctly, it is started to use them in step S506. When it is not confirmed, the process returns to step S503. Note that in step S507, when there is the connection request from the user's terminal apparatus 80 to 82, the antenna part is controlled to provide communication. The process ends in step S508.

FIG. 6 shows an example of the confirmation operation in step S504 in FIG. 5. In step S601, the display communication processing apparatus to perform the setting transmits a confirmation request to the adjacent display communication processing apparatus This is carried out via the control channel (antenna part 110).

Next, in step S602, the adjacent display communication processing apparatus sets the specifications for the test communication based on the request, and directs a beam toward the display communication processing apparatus that has transmitted the confirmation request.

Next, in step S603, communication is attempted between the display communication processing apparatus. When the communication attempt ends normally in step S604, it is assumed that there is no problem, and the setting of the fixed setting communication ends normally, and it is started to use them in step S504. Note that, step S506 in FIG. 5 and FIG. 6 is the same step.

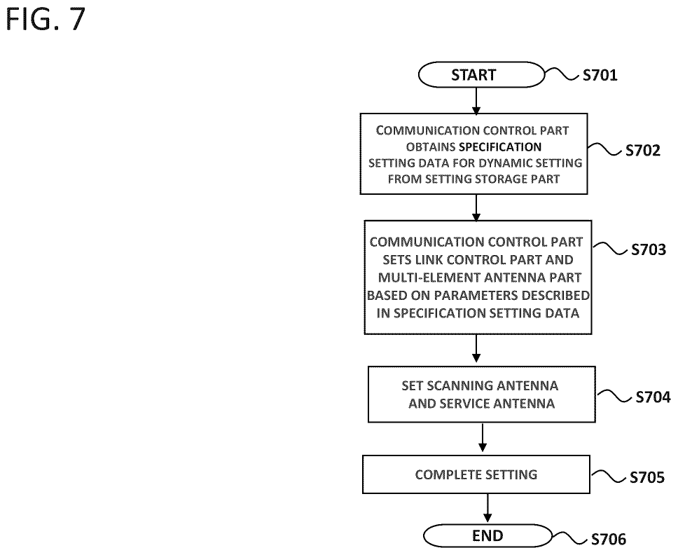

Next, a description will be made regarding the setting of a priority 3. FIGS. 7 to 9 are flowcharts showing an example of the communication control operation with the priority 3 of the second display communication processing apparatus. Note that the setting of the priority 3 is referred to as communication setting of dynamic setting.

Note that, in the setting of the priority 3, it is assumed that the necessary number of sets of antenna parts and the link control parts are available for dynamic setting communication. The minimum number required is two, one is used for scanning radio waves, and the other is used for services. An example of communication control operation of the priority 3 executed by each of the second display communication processing apparatus 10 to 14 will be described with reference to FIGS. 7 to 9.

Referring to FIG. 7, the process starts at step S701. In step S702, the communication control part 140 obtains specification setting data for dynamic setting from the setting storage part 150.

Next, in step S703, the communication control part 140 sets the link control parts 120 to 122 and the antenna parts 110 to 11n based on the parameters described in the specification setting data. Each of the antenna parts 110 to 11n is, as an example, configured by multi-element antennas.

Next, in step S704, the antenna parts 110 to 11n are divided into the scanning antenna part 111 and the service antenna part 11n to be set. Next, in step S705, the setting is completed, and in step S706, the process ends.

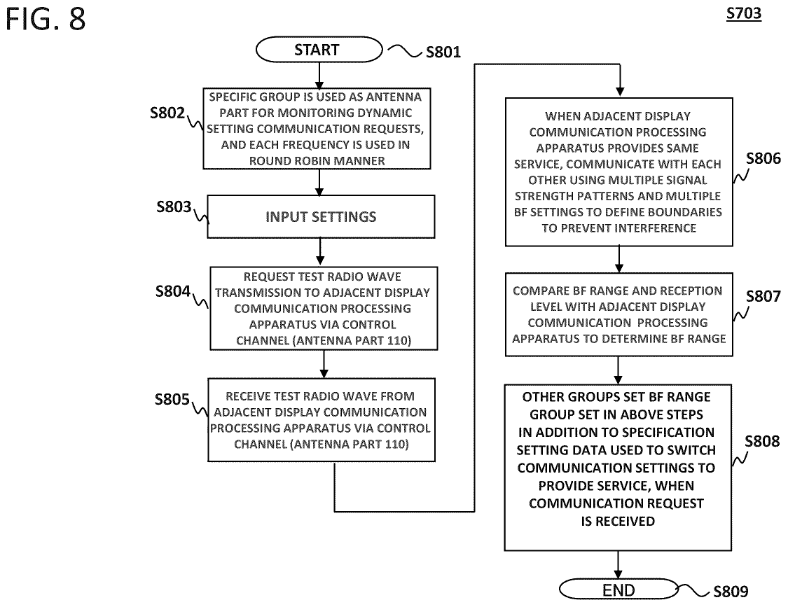

Next, the processing operation of step S703 in FIG. 7 will be described with reference to FIG. 8. The processing starts in step S801 in FIG. 8. In step S802, a specific one set is set as an antenna part for monitoring a communication request of dynamic setting, and each frequency is used in round robin manner.

Next, in step S803, the settings are input.

Next, in step S804, a test radio wave transmission is requested to the adjacent display communication processing apparatus via the control channel (antenna part 110).

Next, in step S805, it is confirmed to the adjacent display communication processing apparatus that test radio waves is received via the control channel (antenna part 110) to function.

Next, in step S806, when the adjacent display communication processing apparatus provides the same service, they communicate with each other with plurality of signal strength patterns and plurality of BF settings to define a boundary for preventing interference.

Next, in step S807, the BF range/reception level are compared with the same of the adjacent display communication processing apparatus, and the BF range is determined.

Next, in step S808, when there is communication request, the other sets additionally set the range of the BF set in the steps S802 to S807 described above in addition to the specification setting data that is to be input to set for providing the service by switching communication settings.

Processing then ends in step S809 and continues to step S704 in FIG. 7.

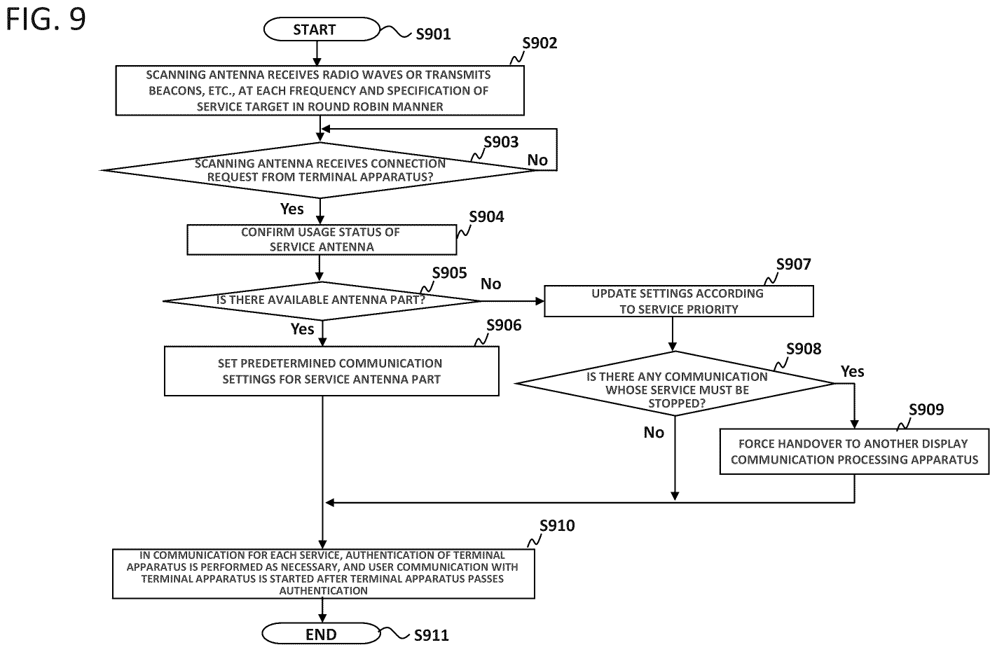

Next, an example of a communication control operation with the priority 3 executed by each of the second display communication processing apparatus 10 to 14 after completion of the dynamic setting will be described with reference to FIG. 9.

The process starts in step S901 in FIG. 9. In step S902, the scanning antenna part 111 receives radio waves or transmits beacons in each of frequencies/specifications of the service target in round robin manner.

In step S903, when the scanning antenna part 111 has not received the connection request from any of the terminal apparatus 80 to 82 (S903 No), the process waits without performing any processing until the connection request is received.

In step S903, when the connection request is received at the scanning antenna part 111 from any of the terminal apparatus 80 to 82 (S903 Yes), in step S904, the usage status of the service antenna part 11n is confirmed.

Next, in step S905, it is checked whether or not there is any available service antenna part 11n. When there is available service antenna part 11n (S905 Yes), in step S906, a predetermined communication setting is made to the service antenna part 11n, and the process proceeds to step S910.

In step S905, when the service antenna part 11n is already full and there is no available space (S905 No), in step S907 the settings are updated according to the priority of the service.

Next, in step S908, it is checked whether there is communication whose service must be stopped. When there is communication whose service must be stopped (S908 Yes), the communication is forcibly handed over to another display communication processing apparatus, and the process proceeds to step S910.

When there is no communication whose service must be stopped (S908 No), the process proceeds to step S910.

In step S910, authentication of the terminal apparatus is performed as necessary for communication of each service, and user communication is started after the terminal apparatus passes the authentication. The authentication information can use information which is obtained from a server environment such as the authentication authorization server 32, or from an adjacent display communication processing apparatus in association with a handover, or information previously stored in the setting storage part 150. The process ends in step S911.

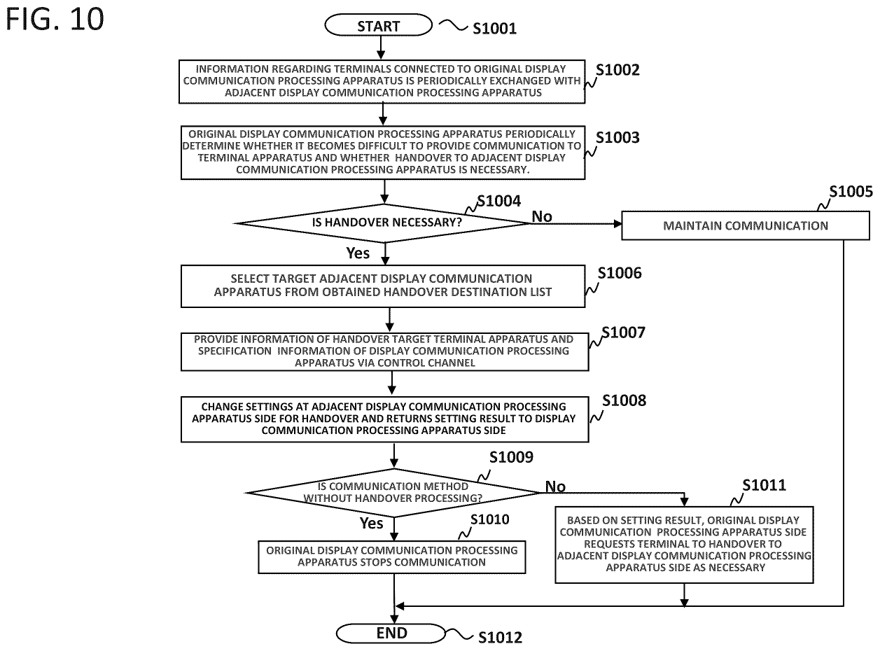

Next, an example of the handover operation of the second display communication processing apparatus will be described with reference to drawings. FIG. 10 is a flow chart showing an example of the handover operation of the second display communication processing apparatus.

Note that, it is assumed that a control channel has already been established between the display communication processing apparatus, as described above, prior to the following handover operation. Also, as an example is shown in step S910 of FIG. 9, for instance, it is assumed that the handover operation is started from a state in which any one of the terminal apparatus 80-82 is connected to the display communication processing apparatus. Here, it is assumed that a display communication processing apparatus to which any one of terminal apparatus 80 to 82 is connected is referred to as the “starting display communication processing apparatus (or starting signage)”, and a display communication processing apparatus adjacent to the starting display communication processing apparatus is referred to as the “adjacent display communication processing apparatus (or adjacent signage)”. Further, it is assumed that each display communication processing apparatus digital (each signage) periodically evaluates/estimates that the beamforming control (BF control) associated with the movement of the terminal apparatus, etc., reaches the service provision limit, and en ters the service area of an adjacent display communication processing apparatus.

Referring to FIG. 10, processing begins in step S1001. Next, in step S1002, information regarding terminals connected to the starting display communication processing apparatus is periodically exchanged with adjacent signage. Note that, at this time, the starting display communication processing apparatus can share history information of the BF control etc. accompanying the movement of the terminal apparatus from which adjacent display communication processing apparatus that are unlikely to be handed over are intentionally omitted.

(1) On the other hand, when the adjacent display communication processing apparatus does not provide the same communication services as those at the starting display communication processing apparatus side, the following responses can be performed.
(A) The adjacent display communication processing apparatus side prepares the same communication services as that at the starting display communication processing apparatus side to make the handover possible;
(B) The adjacent display communication processing apparatus side determines that the handover of the starting display communication processing apparatus side is impossible; and

(2) The adjacent display communication processing apparatus side returns above-mentioned handover possible/impossible to the starting display communication processing apparatus side.

Next, in step S1003, the starting display communication processing apparatus periodically determines whether it becomes difficult to provide communication to the terminal apparatus, and whether handover to an adjacent display communication processing apparatus is necessary.

For example, a handover may be necessary in the following cases:
(1) In a case where it can be expected that the controllable range of the antenna part will be exceeded. This is determined at the antenna part and the link control part;
(2) In a case where the communication quality (transmission and reception levels) with the terminal apparatus continues to be below a threshold; and
(3) In a case where an excess of traffic volume is expected, and a handover is to be performed from user's terminal apparatus far from the display communication processing apparatus. This is determined at the communication control part 140.

When handover is not necessary (step S1004: No), in step S1005, communication is maintained as is, the process proceeds to step S1012, and the process ends.

When handover is necessary (Yes in step S1004), in step S1006, the target adjacent display communication processing apparatus is selected from the handover destination list obtained by returning whether handover is possible/impossible to the starting display communication processing apparatus side at the adjacent display communication processing apparatus side.

Next, in step S1007, information on the terminal apparatus that is the target to be handed over and specification information on the display communication processing apparatus are provided to the adjacent display communication processing apparatus via the control channel (antenna part 110).

Next, in step S1008, the settings for handover are changed at the adjacent display communication processing apparatus side, and the setting results are returned to the starting display communication processing apparatus side.

Next, in step S1009, it is checked whether the communication method on the adjacent display communication processing apparatus side is a communication method without handover processing. When it is a communication method without handover processing (S1009 Yes), in step S1010, the communication is stopped at the starting display communication processing apparatus side, the process proceeds to step S1012, and the process ends.

On the other hand, when the communication method is with handover processing (S1009 No), in step S1011, the starting display communication processing apparatus side requests the terminal apparatus to handover to the adjacent display communication processing apparatus side, as necessary, based on the setting result and then the process proceeds to step S1012, and the process ends.

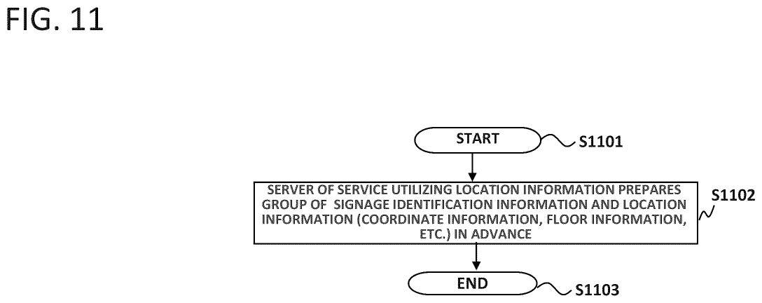

Next, an example of the operation of providing a service utilizing the location information of the second display communication processing apparatus will be described in detail using FIGS. 11 to 19.

First, the server environment preparation operation of a service providing server for a service utilizing the location information will be described. The service providing server also may be, as an example, the external service gateway 60 that provides the external service 70 shown in FIG. 2. FIG. 11 is a flowchart showing the server environment preparation operation of a server for a service utilizing the location information. The processing starts in step S1101.

In step S1102, the service providing server of the service utilizing the location information prepares in advance a set of identification information and location information (coordinate information, floor information, etc.) of the display communication processing apparatus. The advance preparation of the set of the identification information and location information of the display communication processing apparatus may be statically set in advance, or may be automatically generated based on a mutual location determination based on a specific display communication processing apparatus. Note that, as to the automatic generation, it is possible to derive it with high accuracy by using the BF control of the antenna part of the display communication processing apparatus.

When the advance preparation is completed, the process ends in step S1103.

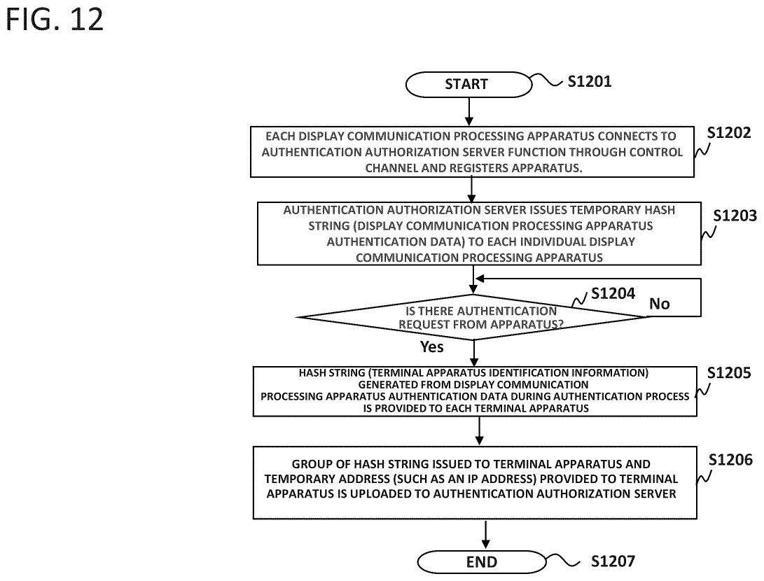

Next, a description will be made regarding preparation operation for the terminal apparatus at the time for the service utilizing the location information of the second display communication processing apparatus. FIG. 12 is a flowchart showing a preparation operation for the terminal apparatus at the time for the service utilizing the location information of the second display communication processing apparatus. The process starts in step S1201.

Next, in step S1202, each display communication processing apparatus side connects with the authentication authorization server 32 through the control channel (antenna 110) to perform part registration of each display communication processing apparatus.

Next, in step S1203, the authentication authorization server 32 issues a temporary hash string (referred to as display communication processing apparatus authentication data) to each individual display communication processing apparatus.

Next, in step S1204, it is checked whether an authentication request has been made from any one of the terminal apparatuses 80 to 82. When there is no authentication request from the terminal apparatus (S1204 No), the authentication request is waited for. If there is an authentication request from the terminal apparatus (S1204 Yes), in step S1205, a hash string (identification information of the terminal apparatus) generated from the display communication processing apparatus authentication data during the authentication process is provided to each terminal apparatus. Thereby, fraudulently generated identification information can be eliminated.

Next, in step S1206, a set of the hash string issued to the terminal apparatus and the temporary address (such as an IP address) issued to the terminal apparatus is uploaded to the authentication authorization server 32, and the process ends in step S1207.

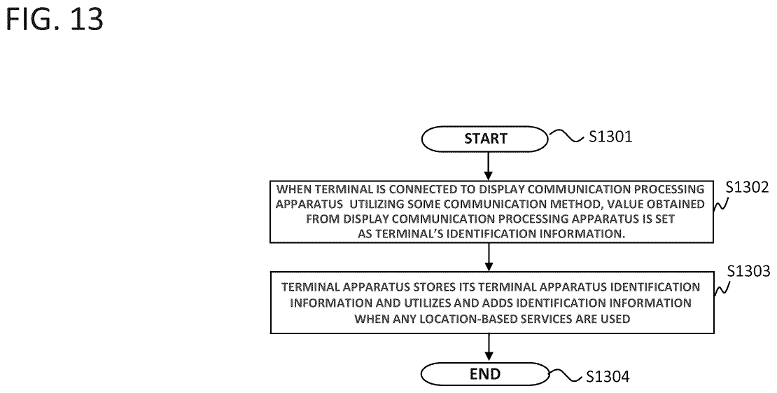

Next, a description will be made regarding a process operation at the time of connection at the time for the service utilizing the location information of the terminal apparatus. FIG. 13 is a flow chart showing a processing operation at the time of connection at the time for the service utilizing the location information of the terminal apparatus. The process starts in step S1301.

Next, in step S1302, when the terminal apparatus is connected to the display communication processing apparatus utilizing some communication method, a value obtained from the display communication processing apparatus is set as the identification information of the terminal apparatus.

Next, in step S1303, the terminal apparatus stores the identification information of the terminal apparatus, and utilizes and adds the identification information of the terminal apparatus when the terminal apparatus uses some location information service. In this case, the terminal apparatus may respond to a request from the display communication processing apparatus, or may periodically deliver the information using a predefined control message. Then, the process ends at step S1304.

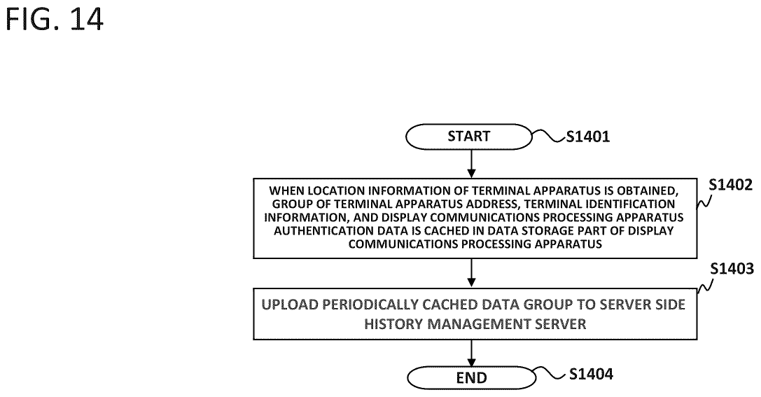

Next, a description will be made below regarding the processing operation by the second display communication processing apparatus at the time of connection of the terminal apparatus at the time of the service utilizing the location information. FIG. 14 is a flowchart showing the processing operation by the second display communication processing apparatus at the time of connection of the terminal apparatus at the time of the service utilizing the location information. In step S1401, processing starts.

Next, in step S1402, when the display communication processing apparatus obtains the location information of the terminal apparatus, a set of the terminal apparatus address, the identification information of the terminal apparatus and display communication processing apparatus authentication data are cached in the data storage part 170 of the display communication processing apparatus itself.

Next, in step S1403, the periodically cached data set (or, also called as data group) is uploaded to the history management server 31. Next, the process ends in step S1404.

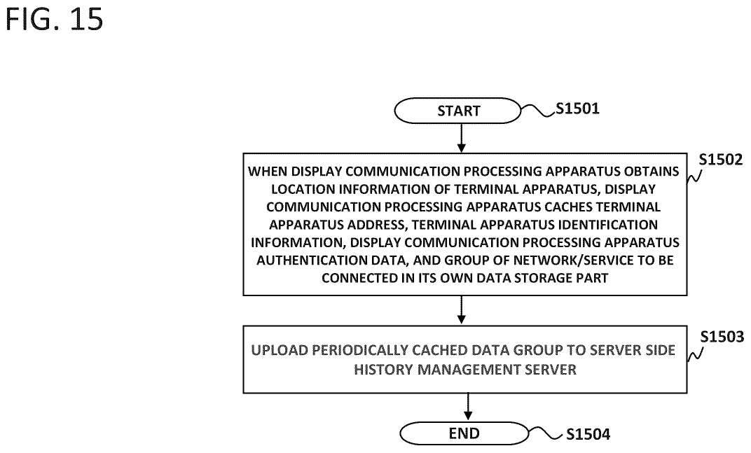

Next, a description will be made regarding the location information processing operation at the time connection of the terminal apparatus at the time of the service utilizing the location information of the second display communication processing apparatus. FIG. 15 is a flowchart showing a location information processing operation at the time connection of the terminal apparatus at the time of the service utilizing the location information of the second display communication processing apparatus. The process starts in step S1501.

Next, in step S1502, when the display communication processing apparatus obtains the location information of the terminal apparatus, the set of the terminal apparatus address, the identification information of the terminal apparatus, display communication processing apparatus authentication data and the network/service to be connected to is cached in the data storage part 170 of the display communication processing apparatus itself.

Next, in step S1503, the periodically cached data set (also called a data group) is uploaded to the history management server 31. Next, the process ends in step S1504.

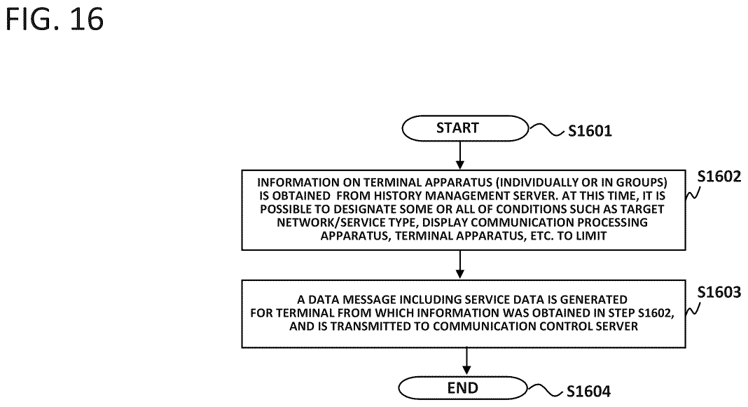

Next, a description will be made regarding the processing operation of the service providing server at the time of the service utilizing location information. The service providing server may be, for example, the external service gateway 60 that provides the external service 70 shown in FIG. 2. FIG. 16 is a flowchart showing a processing operation of a service providing server at the time of the service utilizing the location information. The processing starts in step S1601.

Next, in step S1602, the service providing server obtains information on the terminal apparatus 80 to 82 (individually or in groups) from the history management server 31. At this time, it is possible to designate some or all conditions such as the target network/service type, the display communication processing apparatus, the terminal apparatus, and other conditions etc. to limit.

Next, in step S1603, a data message including service data is generated for the terminal apparatus from which the information was obtained in step S1602 above and is transmitted to the communication control server 30.
(1) At this time, for the sake of efficiency, the destination may be set as a comprehensive expression such as the individual terminal apparatus, an individual display communication processing apparatus, an area, etc. The comprehensive expression is interpreted by the communication control server 30 or an individual display communication processing apparatus to perform distribution to each terminal apparatus.
(2) Note that, the notification range from the display communication processing apparatus may be included in the data message. This can be reflected in the BF control on the display communication processing apparatus side.
(3) The content to be displayed on the display communication processing apparatus may be included in the data message. Next, the process then ends in step S1604.

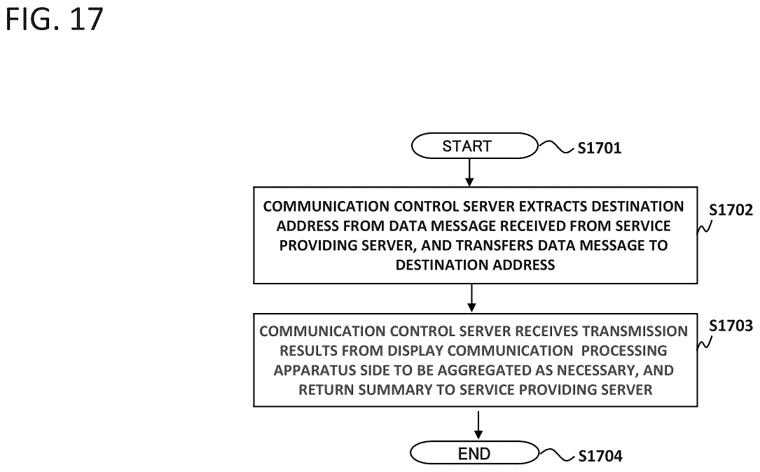

Next, a description will be made regarding the processing operation of the communication control server during the time of the service utilizing the location information. FIG. 17 is a flowchart showing a processing operation of the communication control server at the time of the service utilizing the location information. The process starts in step S1701.

Next, in step S1702, the communication control server 30 extracts the destination to which the data message should be sent from the data message received from the service providing server such as, for example, the external service gateway 60 to transfer the data message to the destination via the control channel antenna part (antenna part 110).

As an example, the following forwarding operations may be performed.
(A) When the destination is the individual terminal apparatus, the data message is forwarded to the display communication processing apparatus to which the terminal apparatus is connected as destination for the individual terminal apparatus.
(B) When the destination is the display communication processing apparatus, the data message is transferred to the display communication processing apparatus as being addressed to the terminal apparatus subordinate to the display communication processing apparatus.
(C) When the destination is an area, a group of the display communication processing apparatus which satisfies a condition is selected to be transferred to the display communication processing apparatus as being addressed to the terminal apparatus subordinate to the display communication processing apparatus group;
(D) When the destination is the individual terminal located in a specific area, the display communication processing apparatus is identified according to the above condition (C), and then the data message is transferred to the relevant display communication processing apparatus as being addressed to the specific terminal.
(E) When the destination is a communication such as a carrier communication whose transmission cannot be controlled by the starting display communication processing system itself, a transmission request is generated to be transmitted to an external server (for example, the carrier gateway 61 shown in FIG. 2).

Next, in step S1703, the transmission results are received from the display communication processing apparatus side to be aggregated as necessary, and to return a summary to a service providing server such as, for example, the external service gateway 60. Finally, the process ends in step S1704.

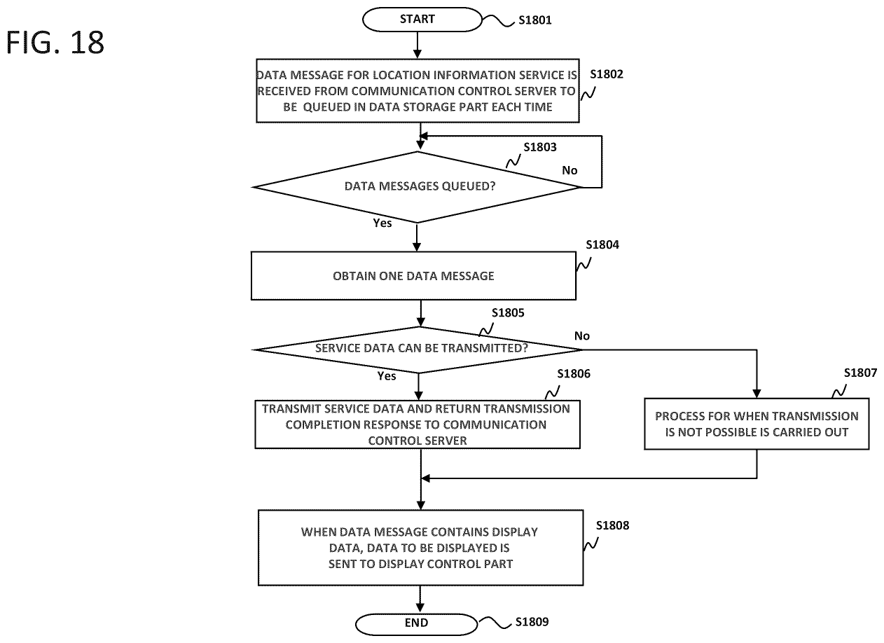

Next, a description will be made regarding service information providing operation at the time of the service utilizing location information by the second display communication processing apparatus. FIG. 18 is a flowchart showing a service information providing operation at the time of the service utilizing the location information by the second display communication processing apparatus. The process starts in step S1801.

Next, in step S1802, the data message for the location information service is received from the communication control server 30 to be queued in the data storage part 170 each time.

Next, in step S1803, it is checked whether a data message for the location information service is queued in data storage part 170. When the data message for the location information service is queued in the data storage part 170 (S1803 Yes), one data message is obtained in step S1804 to perform transmission processing according to the procedure following step S1805. When no data message for the location information service is queued in the data storage part 170 (S1803 No), the process waits in step S1803.

Next, in step S1805, it is determined whether or not the service data can be transmitted. This determination is made by checking, for example,
(1) whether the data message is transmission target message of the service data;
(2) whether the target communication service is operating;
(3) whether during service hours;
(4) whether within the service area, etc.; and
(5) whether the destination terminal apparatus exists in the starting display communication processing apparatus (for example, whether it is subordinate).

When the service data can be transmitted (S1805 Yes), the service data is transmitted in step S1806, and a transmission completion response is returned to the communication control server 30. Note that, the data transmission is transmitted from the data processing and storing part 160 via the data exchange part 130 and the service antenna part 11n to the terminal apparatus that has requested the service among the terminal apparatus 80 to 82. In addition, when advanced control such as area limitation by the BF is required, a control request is sent to the communication control part 140 within the display communication processing apparatus, and the concrete control is generated in the communication control part 140 to implement directional control and output control, etc. of the antenna part 110 via the ring control part 120.

On the other hand, when the service data cannot be transmitted (S1805 No), the process for when transmission is not possible is carried out in step S1807. The description will be made later regarding process in case that the transmission is not possible.

Next, in step S1808, when the data message contains display data, the data to be displayed is sent to the display control part 190.

Finally, the process ends in step S1808.

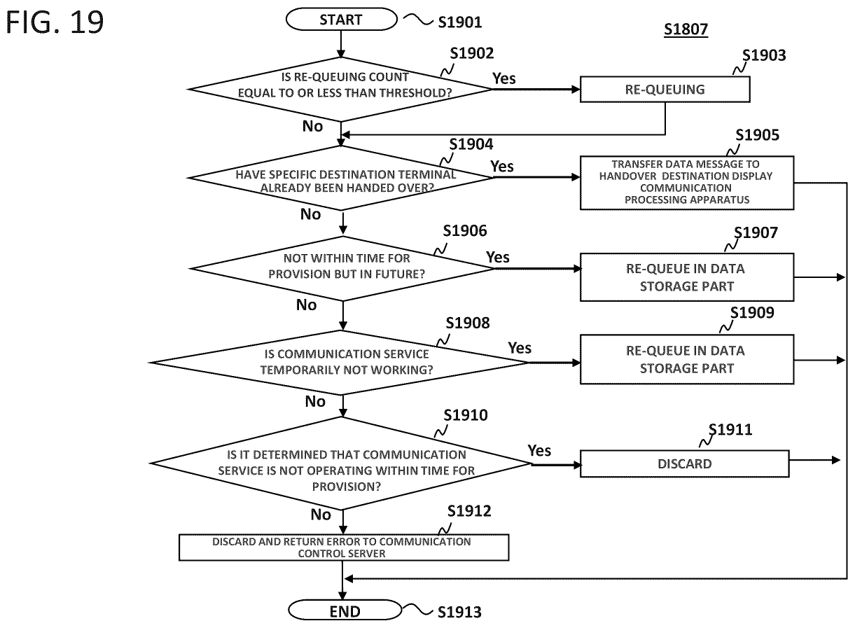

Next, in step S1805 of FIG. 18, a description will be made with reference to FIG. 19 regarding the process in case transmission is not possible (step S1805 No). FIG. 19 is a flowchart showing a service information providing operation by the second display communication processing apparatus at the time of a service utilizing the location information. FIG. 19 shows an example of the operation of step S1807 described in FIG. 18. The process starts at step S1901.

Next, in step S1902, when the re-queuing count is equal to or less than a threshold (S1902 Yes), the process proceeds to step S1903, where the data message is re-queued, and the process proceeds to step S1904. When the re-queuing count is not equal to or less than the threshold (S1902 No), the process proceeds to step S1904.

Next, in step S1904, when a specific destination terminal apparatus has been handed over (S1904 Yes), the process proceeds to step S1905, where the data message is transferred to the display communication processing apparatus of the handover destination, and the process proceeds to step S1913, where the process ends. Note that, the display communication processing apparatus of the handover destination is determined as shown in FIG. 10. When the specific destination terminal apparatus has not been handed over (S1904 No), the process proceeds to step S1906.

Next, in step S1906, when it is not within the time for provision but in the future, (S1906 Yes), the process proceeds to step S1907, where the data message is re-queued in the data storage part, and the process proceeds to step S1913, where the process ends. When it is within the time for provision (S1906 No), the process proceeds to step S1908.

Next, in step S1908, when the target communication service is temporarily not operating (S1908 Yes), the process proceeds to step S1909, where the data message is re-queued in the data storage part, and the process proceeds to step S1913, where the process ends. When the target communication service is operating (S1908 No), the process proceeds to step S1910.

Next, in step S1910, when it is determined that the communication service is not operating within the time to be provided (S1910 Yes), the process proceeds to step S1911, where the service data is discarded, and the process proceeds to step S1913, where the process ends. When it is not determined that the communication service is not operating within the time to be provided (S1910 No), the process proceeds to step S1912 where the service data is discarded and return an error to the communication control server, and then the process proceeds to step S1913 where the process ends.

As described above, the second display communication processing apparatus provide the terminal apparatus with the service data (or service information) at the time of the service utilizing the location information.

As described above, according to the first example embodiment, it is possible to provide a display communication processing apparatus, a control method for the display communication processing apparatus, a terminal apparatus and a program that contribute to reducing the time required for installation design and construction of digital signage.

Further, according to the first example embodiment, it is possible to efficiently provide services according to the situation (location) of the user.

Further, according to the first example embodiment, the display communication processing apparatus can be made thinner and lighter, because a massive-element display antenna can be provided on the display screen of the display communication processing apparatus.

Furthermore, according to the first example embodiment, the display communication processing apparatus can be connected to the external service gateway, the carrier gateway and the business service gateway via a network and the communication control switch, whereby the display communication processing apparatus is allowed to be applied to various services.

Although each example has been described above, the present invention is not limited to the above-mentioned example embodiments, and further modifications, substitutions, and adjustments can be made without departing from the basic technical concept of the present invention. For example, the network configurations, the element configurations, and the message expression formats shown in each of the drawings are examples to facilitate understanding of the present invention. Thus, the present invention is not limited to the configurations illustrated in the drawings. In addition, “A and/or B” is used to signify at least one of A or B.

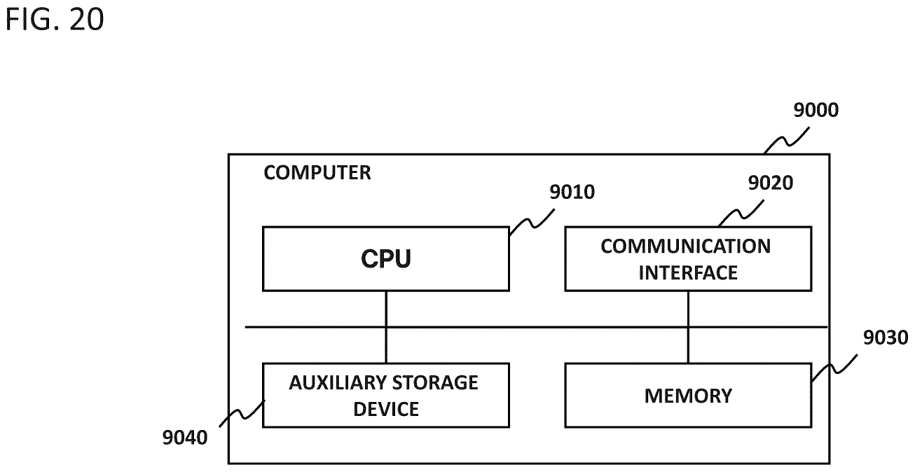

Furthermore, the procedures shown in the first example embodiment can be realized by a program that causes a computer (9000 in FIG. 20) that functions as the display communication processing apparatus, the link control part or the communication control part to realize the functions of the display communication processing apparatus, the link control part, or the communication control part. Such a computer is exemplified by a configuration including a CPU (Central Processing Part) 9010, a communication interface 9020, a memory 9030, and an auxiliary storage device 9040 in FIG. 20. That is, the CPU 9010 in FIG. 20 executes a control program for the display communication processing apparatus, the link control part, or the communication control part, and performs an update process for each calculation parameter held in the auxiliary storage device 9040, etc.

The memory 9030 is a RAM (Random Access Memory) and a ROM (Read Only Memory), etc.

In other words, each part (processing means, functions) of the display communication processing apparatus, the link control part or the communication control part shown in the first example embodiment described above can be realized by a computer program that causes the processor of the computer to execute each of the above-mentioned processes utilizing its hardware.

Finally, the preferred modes of the present invention are summarized as follows.

### Mode 1

(See the display communication processing apparatus according to the above first aspect of the present invention)

### Mode 2

Preferably, the display communication processing apparatus according to mode 1, wherein identification information of a terminal apparatus is provided to the terminal apparatus, when an authentication request is received from the terminal apparatus via the third antenna part by the communication control part.

### Mode 3

Preferably, the display communication processing apparatus according to mode 1 or 2, wherein the identification information of the terminal apparatus is a hash string generated from display communication processing apparatus authentication data obtained from an authentication authorization server.

### Mode 4

Preferably, a display communication processing apparatus according to any one of modes 1-3, wherein a terminal address of the terminal apparatus, the identification information of the terminal apparatus, the display communication processing apparatus authentication data and data of a set of a service and a network to be connected are cached in a data storage part, and the periodically cached data is uploaded to the history management server, when a request for a location information service to which the identification information of the terminal apparatus is attached is received from the terminal apparatus by the communication control part via the third antenna part.

### Mode 5

Preferably, a display communication processing apparatus according to any one of modes 1-4, a data message including service data for the location information service generated by a service providing server based on data stored in the history management server transmitted from a communication control server is received via the first antenna part.

### Mode 6

Preferably, the display communication processing apparatus according to any one of modes 1-5, wherein the service from the network is provided to the terminal apparatus by transmitting the service data of the location information service included in a data message to the terminal apparatus via the third antenna part by the communication control part.

### Mode 7

Preferably, a display communication processing apparatus according to any one of modes 1-6, wherein the service from the network is provided to the terminal apparatus by transferring the service data to the adjacent display communication processing apparatus at a handover destination via the link with the adjacent display communication processing apparatus and by transmitting the service data to the terminal apparatus via the third antenna part of the plurality of antenna parts of the adjacent display communication processing apparatus by the communication control part of the adjacent display communication processing apparatus at a handover destination, when the terminal apparatus has moved and handed over to the adjacent display communication processing apparatus.

### Mode 8

(See the terminal apparatus according to the above second aspect of the present invention)

### Mode 9

Preferably, the terminal apparatus according to mode 8, wherein identification information of the terminal apparatus is a hash string that the display communication processing apparatus generates from display communication processing apparatus authentication data obtained from an authentication authorization server.

### Mode 10

(See the control method for a display communication processing apparatus according to the above third aspect of the present invention)

### Mode 11

(See the program according to the above fourth aspect of the present invention)

Note that Modes 10 and 11 can be expanded to Modes 2 to 7, in the same way as Mode 1.

Note, the disclosure of each of the above Patent Literatures is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. Furthermore, the disclosures of the above cited documents, if necessary, in accordance with the gist of the present invention, as part of the disclosure of the present invention, in part or in whole, may be used in combination with the description of this document, and are considered to be included in the disclosures of this application.

### REFERENCE SIGNS LIST

1: display communication processing system
10, 11, 12, 13, 14: display communication processing apparatus
20: gateway apparatus
30: communication control server
31: history management server
32: authentication authorization server
40: network
50: communication control switch
60: external service gateway
61: carrier gateway
62: business service gateway
70: external service
71: carrier
72: internal business service
80, 81, 82: terminal apparatus
110, 111, 11n: antenna part
120, 121, 122, 124: link control part
130: data exchange part
140: communication control part
150: setting storage part
160: data processing and storage part
170: data storage part
180: display part
190: display control part
9000: computer
9010: CPU
9020: communication interface
9030: memory
9040: auxiliary storage device

What is claimed is:

1. A display communication processing apparatus including a plurality of antennas, a link controller, a communication controller and a display, wherein
the plurality of antennas are provided on a display screen of the display,
a link with an adjacent display communication processing apparatus via a first antenna of the plurality of antennas is established by the link controller,
a network is connected via the first antenna by the communication controller,
a predetermined communication setting for a third antenna of the plurality of antennas is set by the communication controller, when a connection request is received from a terminal apparatus via a second antenna of the plurality of antennas, and
a service from the network to the terminal apparatus via the third antenna is provided by the communication controller.

2. The display communication processing apparatus according to claim 1, wherein identification information of the terminal apparatus is provided to the terminal apparatus, when an authentication request is received from the terminal apparatus via the third antenna by the communication controller.

3. The display communication processing apparatus according to claim 2, wherein the identification information of the terminal apparatus is a hash string generated from display communication processing apparatus authentication data obtained from an authentication authorization server.

4. The display communication processing apparatus according to claim 3, wherein a terminal address of the terminal apparatus, the identification information of the terminal apparatus, the display communication processing apparatus authentication data and data of a set of a service and a network to be connected are cached in a data storage, and the periodically cached data is uploaded to a history management server, when a request for a location information service to which the identification information of the terminal apparatus is attached is received from the terminal apparatus by the communication controller via the third antenna.

5. The display communication processing apparatus according to claim 4, wherein a data message including service data for the location information service generated by a service providing server based on data stored in the history management server transmitted from a communication control server is received via the first antenna.

6. The display communication processing apparatus according to claim 5, wherein the service from the network is provided to the terminal apparatus by transmitting the service data of the location information service included in a data message to the terminal apparatus via the third antenna by the communication controller.

7. The display communication processing apparatus according to claim 5, wherein the service from the network is provided to the terminal apparatus by transferring the service data to the adjacent display communication processing apparatus at a handover destination via the link with the adjacent display communication processing apparatus and by transmitting the service data to the terminal apparatus via the third antenna of the plurality of antennas of the adjacent display communication processing apparatus by the communication controller of the adjacent display communication processing apparatus at a handover destination, when the terminal apparatus has moved and handed over to the adjacent display communication processing apparatus.

8. A terminal apparatus that transmits a request for a location information service to which identification information of a terminal apparatus provided by a display communication processing apparatus is added to the display communication processing apparatus.

9. The terminal apparatus according to claim 8, wherein the identification information of the terminal apparatus is a hash string that the display communication processing apparatus generates from display communication processing apparatus authentication data obtained from an authentication authorization server.

10. A control method for a display communication processing apparatus performed by a computer included in the display communication processing apparatus including a plurality of antennas and a display, the plurality of antennas are provided on a display screen of the display, the method comprising:
establishing a link with an adjacent display communication processing apparatus via a first antenna of the plurality of antennas;
connecting to a network via the first antenna;
performing a predetermined communication setting for a third antenna of the plurality of antennas, when a connection request is received from a terminal apparatus via a second antenna of the plurality of antennas; and
providing a service from the network to the terminal apparatus via the third antenna.

11. The control method according to claim 10, further comprising:
providing identification information of the terminal apparatus to the terminal apparatus, when an authentication request is received from the terminal apparatus via the third antenna.

12. The control method according to claim 11, wherein the identification information of the terminal apparatus is a hash string generated from display communication processing apparatus authentication data obtained from an authentication authorization server.

13. The control method according to claim 12, further comprising:
caching a terminal address of the terminal apparatus, the identification information of the terminal apparatus, the display communication processing apparatus authentication data and data of a set of a service and a network to be connected in a data storage, and uploading the periodically cached data to a history management server, when a request for a location information service to which the identification information of the terminal apparatus is attached is received from the terminal apparatus via the third antenna.

14. The control method according to claim 13, further comprising:
receiving a data message including service data for the location information service generated by a service providing server based on data stored in the history management server transmitted from a communication control server via the first antenna.

15. The control method according to claim 14, further comprising:
providing the service from the network to the terminal apparatus by transmitting the service data of the location information service included in a data message to the terminal apparatus via the third antenna.

16. The control method according to claim 14, further comprising:
providing the service from the network to the terminal apparatus by transferring the service data to the adjacent display communication processing apparatus at a handover destination via the link with the adjacent display communication processing apparatus and by transmitting the service data to the terminal apparatus via the third antenna of the plurality of antennas of the adjacent display communication processing apparatus by the adjacent display communication processing apparatus at a handover destination, when the terminal apparatus has moved and handed over to the adjacent display communication processing apparatus.
